(19) United States
(12) Patent Application Publication
(10) Pub. No.: US 2013/0314469 A1
(43) Pub. Date: Nov. 28, 2013

(54) PRINTHEAD MOUNTING AND ADJUSTING MECHANISM FOR INKJET PRINTER

(71) Applicant: Yuan Chang, Newtown Square, PA (US)

(72) Inventor: Yuan Chang, Newtown Square, PA (US)

(21) Appl. No.: 13/952,672

(22) Filed: Jul. 29, 2013

Related U.S. Application Data
(62) Division of application No. 13/187,544, filed on Jul. 21, 2011.

(30) Foreign Application Priority Data
Jul. 22, 2010 (CN) 201010237291.8

(51) Int. Cl. B41J 2/135

(52) U.S. Cl. CPC B41J 2/135
USPC 347/20

(57) ABSTRACT

The mechanism include a bottom bracket and a base plate, the bottom bracket is mounted on the base plate to provide accurate Y-axis movement and adjustment, wherein also include a top bracket which is mounted on the bottom bracket for providing angle adjustment of the print head. Micrometer screw head is used as the adjustment mechanism for fine precision adjustment. The print head and the adjustment mechanism are two separate parts, so exchanging or adjusting it will not damage the print heads. Remounting a print head requires a slight adjustment to reach the desired position reducing labor intensity and making for easier maintenance to the print heads.

### CROSS-REFERENCE TO RELATED APPLICATIONS

This application is a divisional application of U.S. application Ser. No. 13/187,544 filed on Jul. 21, 2011 all of which is herein incorporated by reference.

### FIELD OF THE INVENTION

The present invention relates to a print head mounting and adjusting mechanism for inkjet printer; particularly to a mechanism for precisely adjusting the position of the high resolution print head; and more particularly to a mechanism which using two stainless steel round shafts to support one print head, and adjusting the print head moving along the stainless steel round shaft by the micrometer screw head.

### BACKGROUND OF THE INVENTION

An inkjet printer is an apparatus for printing on a surface of a sheet-like medium by ejecting ink droplets from a print head. As shown in FIG. 1, a general single pass inkjet printer 01 includes print module 001, frame 002, printing area 003 and control system. The print module 001 mounts on the frame 002, in printing process, the print module 001 is stationary, the control system controls the drive motor driving the sheet-like medium move under the print head in one direction. The print head assembly 0011 which is mounted on the print module 001 is used for mounting the print heads. The control system also sends data and controls the print heads jetting inks onto the sheet-like medium to form the image and text.

Depending on the print head model, a single inkjet print head can have hundreds, if not thousands, of nozzles arranged at 600DPI nozzle pitch jetting ink droplets several thousand times a second. A large amount of the printing data is required to place each drop precisely where it is supposed to be deposited on the medium; otherwise the printed image will have obvious errors, especially in the case of printing multiple colors. Inkjet printers usually use one row of print heads line up in parallel on a base plate to increase the printing speed (such as use two paralleled print heads to achieve double speed printing), or the number of color inks used such as CMYK ink color. Also it can use one row of print heads line up in a line on a base plate to increase the printing width. In color printing process, it is important to mount the print heads parallel to each other on a base plate so that the first nozzle of each print head line to make sure the print heads jet ink in the exact point on the medium. In page width printing process, it requires the first nozzle of one print head is connected with the last nozzle of the another print head. Despite the need for high precision, print head manufacturing errors along with component assembly errors and defects cause the print heads to come out of alignment. As seen in prior art, print heads are mounted on a base plate with adjustment mechanisms to compensate for alignment errors.

Referring to FIG. 2, three parameters determine the relative location between two print heads; those are:

1. The angle (Δa) between the print head and the vertical line. In printing, all the print heads should be parallel relative to a reference head, that is to say the Δa is a fixed value in which Δa=0;

2. The distance (ΔX) between two print heads in the X axis direction. In the present invention, it can be adjusted by the software;

3. The distance (ΔY) between two print heads in the Y-axis direction. In printing, the requirement is that the first nozzle of each print head which jets a different color ink must be in a horizontal line, that is to say, ΔY=0. The distance (ΔY) between the first nozzle of two print heads which jet the same color ink can be d/n to improve the printing precision (d is the distance between two adjacent nozzles in one print head; n is the amount of the print heads mounting on the base plate, which jetting the same color ink).

The relative location between two print heads can be adjusted using mechanical methods or software methods. The relative position between two print heads in the X axis direction can be adjusted by software; however, it is not possible to use software to adjust the relative position between two print heads in the Y-axis direction without wasting nozzle or the angle between print head and the vertical line. In prior art, eccentric screws and taper screws are mainly used for adjusting the print heads mounted on the base plate. After mounting the print heads on the base plate or exchanging a print head, the print head must be readjusted in order to obtain a good printing quality.

In prior art, after adjusting the print heads, the locking process may interfere the position. It is difficult to ensure the needed precision using eccentric screws and taper screws in adjusting the high precision print heads. Moreover, in prior art, the eccentric screws and taper screws come in direct contact with the print heads, resulting in wear and damage to the print heads after extended use.

### SUMMARY OF THE INVENTION

The objective of the present invention is to provide a simple structure and mechanism that is easy to maintain for mounting and adjusting high resolution wide print heads (such as Kyocera, or Xaar 1001) in two directions, namely ΔY and Δa.

Another objective of the present invention is to provide a mechanism which using two stainless steel round shafts to support one print head and adjusting the print head moving along the stainless steel round shaft by the micrometer screw head.

Additional objective and advantages of the invention will be set forth in part in the description which follows and, in part, will be obvious from the description, or may be learned by practice and usage of the invention.

To achieve the above mentioned objectives, the present invention propose a print head mounting and adjusting mechanism include a bottom bracket and a base plate, the bottom bracket is installed on the base plate, the bottom bracket can be used for mounting print head, wherein said bottom bracket is supported by two stainless steel round shaft which is mounted on the base plate to provide accurate Y-axis movement and adjustment.

The bottom bracket have rail guide features on each long side right and left of the bracket; right side has two slot guide with upside down U ( [symbol] ) shape on each end of the bottom bracket, these two slot guide rides on one stainless steel round shaft; left side has one flat plane guide wing on the middle of the bottom bracket, this left side guide wing rides on another stainless steel round shaft.

There is also a head through hole formed in the middle of the bottom bracket. Altogether, the bottom bracket holds five pins, two positioning pins are set at the front and rear end of the bottom bracket; and a rotation pivot pin is located near the rear end of the bottom bracket.

The bottom bracket and the stainless steel round shaft are mounted on the base plate. The Y-axis adjustment mechanism is mounted at the front end of the base plate. The end point of the Y-axis adjustment mechanism contacts with the side wall of the bottom bracket.

The mechanism also include a head mounting bracket, there is a mounting hole in the middle of the head mounting bracket for installing print head.

The mechanism also include a top bracket which is mounted on the bottom bracket for providing angle adjustment of the print head. The front end of the top bracket has a mounting block for mounting the angle adjustment mechanism.

The middle of the top bracket has a rectangular head through hole. The rear end of the top bracket has a through hole, and the front end of the top bracket has a mounting block on which is mounted the angle adjustment mechanism.

More particularly, between the bottom bracket and the base plate there is a pair of Y-axis restoring spring at the rear side to the base plate which provides opposite force on the bottom plate for the Y-axis adjustment mechanism situated on the front of the base plate; the two Y-axis restoring springs are mounted on a pair of base plate blind hole at the rear of the base plate; one end of the restoring spring presses on the end of the of the base plate blind hole on the base plate, while the other end of the Y-axis restoring spring presses on the rear wall of the bottom bracket.

More particularly, between the bottom bracket and top bracket there is a pair of angle restoring springs at the front of the top bracket which works with the angle adjustment mechanism; the angle restoring spring is fitted on the two top bracket blind holes at the front of the top bracket; one end of the angle restoring spring presses at the end of the top bracket blind hole on the top bracket, while the other end of the angle restoring spring presses on the side wall of the bottom bracket.

More particularly, the number of Y-axis adjustment mechanisms and the number of angle adjustment mechanisms are equal with the number of print heads designed on the base plate.

More particularly, the Y-axis adjustment mechanisms and the angle adjustment mechanisms are micrometer screw heads for fine precision adjustments.

More particularly, on each of the two ends of said bottom bracket are a pair of positioning pins, the front and rear bracket fixing block and the bottom bracket are mated together by the two positioning pins on each end of the bottom bracket.

More particularly, the bottom bracket and the top bracket are locked by the bracket fixing block with locking screws.

More particularly, all said bottom brackets mounted on a base plate are fixed by the front and rear fixing bar with locking screws.

More particularly, There are spring loaded screws equipped with a compressed spring beside each locking screw. The spring loaded screw has self lock function to ensure the adjustment position does not move if there is no external force from adjusting the Y-axis adjustment mechanism or the angle adjustment mechanism.

More particularly, there is one threaded hole on each of the head mounting bracket for easy dismounting of the print head. A screw can be used to push and separate the print heads from the top bracket.

More particularly, there are five L-shaped corner slots formed on the base plate for holding the stainless steel round shaft. The fixing plate presses the stainless steel round shaft into the L-shaped corner slots and lock it with the screw.

During assembly, put the stainless steel round shaft into the base plate and lock it with the fixing plate and screws on it, then put the bottom bracket on the stainless steel round shaft. The upside down U ( [symbol] ) shape groove of the two slot guide at the right side of the bottom bracket as well as the flat plane guide each contact with a stainless steel round shaft. The bottom bracket can then move along the stainless steel round shaft.

Next, put the top bracket onto the bottom bracket. Mate the locating hole on the top bracket with the rotation pivot pin on the bottom bracket. Install the angle adjustment mechanism on the top bracket. The top bracket can rotate around the rotation pivot pin by adjusting the angle adjustment mechanism. Fix the bottom bracket on the base plate, and then install the print head on the head mounting bracket. Finally install the head mounting bracket, which is fixed with print head, on the top bracket from the bottom up;

After assembly, the bottom bracket can fine move along the stainless steel round shaft in the Y-axis direction by adjusting the Y-axis adjustment mechanism; the print head will move as the bottom bracket moves. When adjusting the angle adjustment mechanism, the bottom bracket will rotate against the top bracket. The print head will rotate as the top bracket rotate. After making adjustments, all the print heads mounted on the base plate are parallel to each other completely and the first nozzle of all the print heads is on a horizontal line. To check for alignment a print pattern with lines is printed on the paper to confirm the calibration.

As apparent from the foregoing description, it can be appreciated that the mechanism for mounting and adjusting the print head in the present invention has the following advantages:

1. Using two stainless steel round shafts to guide the print head moving along the Y-axis direction can ensure no deflection in the moving process, the stainless steel round shaft can also give a smooth sliding surface for the Y-axis adjustment mechanism.

2. Between two neighboring print heads the stainless steel round shaft can be shared to reduce the spacing between print heads, so that the width of the base plate can be reduced.

3. The Y-axis adjustment and the angle adjustment are done on two separate bracket, in the adjusting process. The Y-axis adjustment and the angle adjustment will not affect each other.

4. Using micrometer screw head as the adjustment mechanism, the adjustment precision can be accurate to 0.01 mm. The mechanism in the present invention can be easily adjusted to ensure all the print heads that jet different colors of ink are parallel to each other, and the first nozzle of all the print heads which jet the same color of ink are in a horizontal line. It can also adjust the print heads which jet the same color ink into a staggered position with each other to improve the printing resolution.

5. The present mechanism is especially used for the print head which width is larger than 2 inch and printing resolution is higher than 300DPI, such as Kyocera print head which width is 4.2 inch and printing resolution is 600DPI.

6. There are spring loaded screws besides each of the locking screws to ensure the accuracy of the adjustment. When adjusting a print head to a required position, the print head will not move to another position in condition that there is no external force; also the restoring spring cannot change the position.

7. When one print head breaks down, the print head just needs to be dismounted from the head mounting bracket bottom. The adjusting parts keep immobile. After remounting the print head, it needs no adjusting or just a little adjusting of the adjustment mechanisms to reach the requirement position. The present invention can reduce labor by saving the adjusting time, and make the maintenance easier to change heads.

8. The adjustment mechanism never contact with the print head, so it can prevent the print heads from damage when multiple adjustment are required.

### BRIEF DESCRIPTION OF THE DRAWINGS

The accompanying drawings, which are included to provide a further understanding of the invention and are incorporated in and constitute as part of this specification, illustrate embodiments of the invention, and together with the description serve to explain the principles of the invention.

FIG. 1 is a perspective view of a general one pass inkjet printer;

FIG. 2 is a schematic diagram showing the relative position between two print heads in prior art;

FIG. 3 is a perspective view, in accordance with the first embodiment of the present invention;

FIG. 4 is the partial enlarged view of FIG. 3, in accordance with the first embodiment of the present invention;

FIG. 5 is a partial exploded view, in accordance with the first embodiment of the present invention;

FIG. 6 is a perspective view of the adjusting part, in accordance with the first embodiment of the present invention;

FIG. 7 is a partial exploded view of the adjusting part, in accordance with the first embodiment of the present invention;

FIG. 8 is a perspective view of the base plate, in accordance with the first embodiment of the present invention;

FIG. 9 is a perspective view of the bottom bracket, in accordance with the first embodiment of the present invention;

FIG. 10 is a perspective view of the top bracket, in accordance with the first embodiment of the present invention;

FIG. 11 is a top view of the adjusting part, in accordance with the first embodiment of the present invention;

FIG. 12 is a cross section on the line A-A of FIG. 10 and

FIG. 13 is a schematic diagram showing the print heads arrangement in accordance with the second embodiment of the present invention.

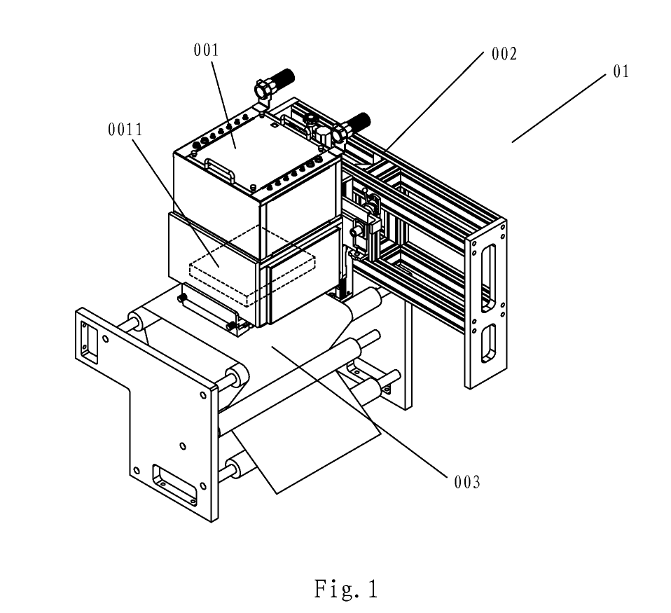

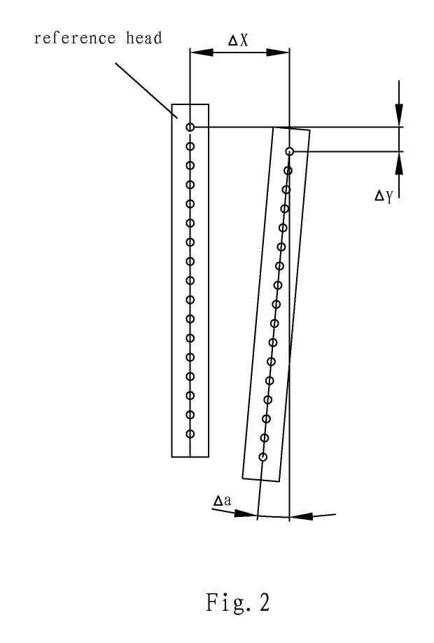

### DRAWINGS—REFERENCE NUMERALS

01—Inkjet printer
001—print module
002—frame
003—printing area
0011—print head assembly
1—base plate
2—print head
3—head mounting bracket
4—fixing bar
5—bracket fixing block
6—top bracket
7—bottom bracket
8—stainless steel round shaft
11—Y-axis adjustment mechanism
12—mounting hole
13—base plate blind hole
14—L-shaped corner slots
31—positioning pin
33, 41, 42, 52—locking screw
34, 35—thread hole
43, 51—spring loaded screw
44, 53—compressed spring
60, 70—head through hole
61—angle adjustment mechanism
62—through hole
63—mounting block
64—top bracket blind hole
65—slotted hole
72—rotation pivot pin
73, 74—slot guide
731, 741—upside down U( [symbol] ) shape groove
75—flat plane guide
81—fixing plate
S1-S9—stainless steel round shaft
C1-C2, M1-M2, Y1-Y2, K1-K2—print head

### DETAILED DESCRIPTION OF PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

### First Embodiment

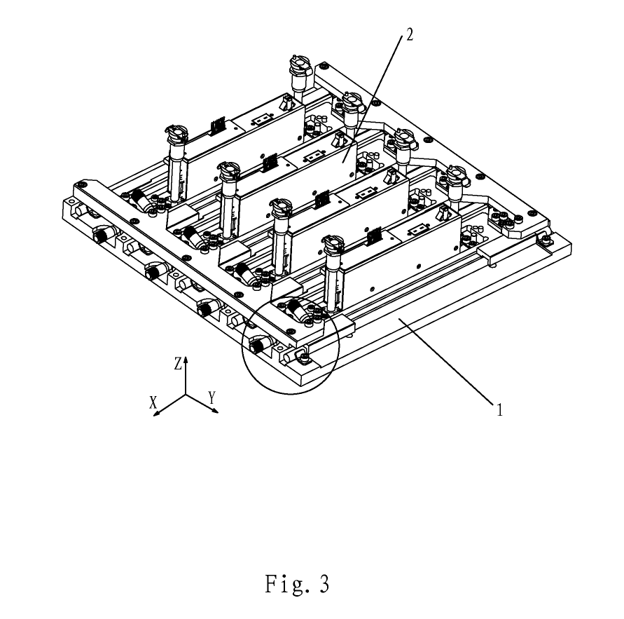

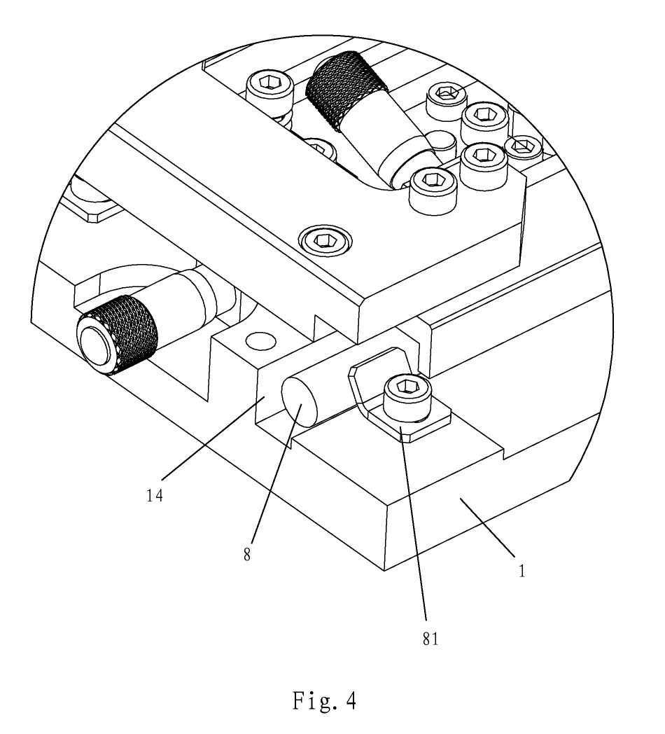

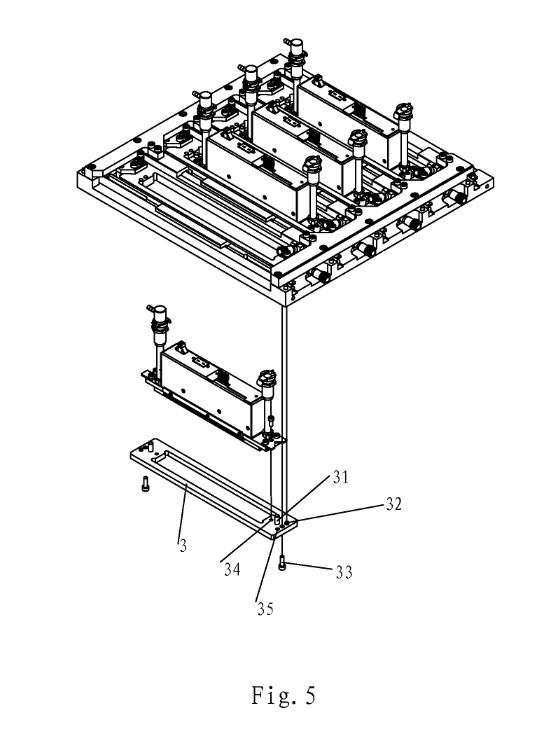

Use four print heads mounted on the base plate for printing color images and text as an example. As shown in FIGS. 3, 4 and 5, the print head mounting and adjusting mechanism in accordance with the first embodiment of the present invention, includes print head 2, head mounting bracket 3 and base plate 1. At front end of print head 2 is a V-shaped notch; at the rear end of print head 2 is an [symbol] -shaped notch. Two ends of the head mounting bracket 3 each set a thread holes 34 for locking the print head 2. The print head 2 is mounted on the head mounting bracket 3 from the top down. And two ends of the head mounting bracket 3 each set a positioning pins 31, the V-shaped notch and [symbol] -shaped notch of print head 2 are fitted with the two positioning pins 31.

As shown in FIG. 8, four mounting holes 12 are formed on the base plate 1 for mounting four bottom brackets 7. Two base plate blind holes 13 are on the side wall of each mounting hole 12. An Y-axis restoring spring disposed in the base plate blind hole 13. There are five L-shaped corner slots 14 formed on the base plate 1 for holding five stainless steel round shafts 8.

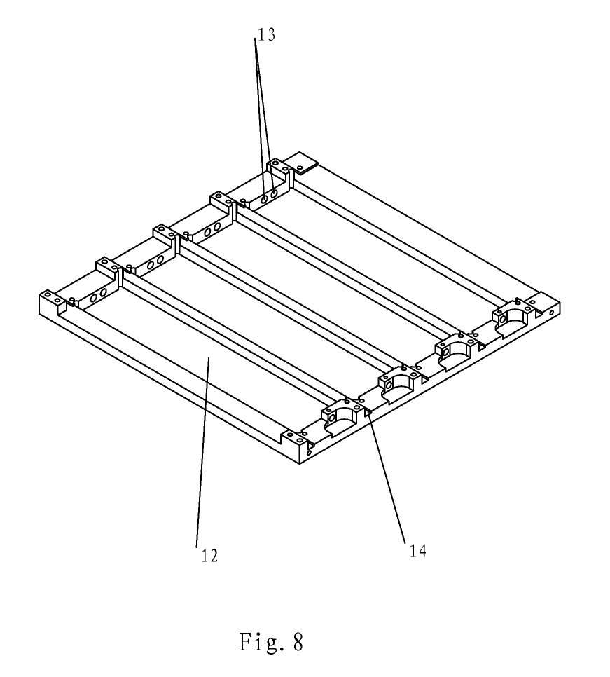

As shown in FIG. 9, bottom bracket 7 includes a head through hole 70, Two slot guides 73, 74 and one flat plane guide 75 are formed on each of the right and left side of the bottom bracket 7 on the length direction. The slot guide 73 and slot guide 74 are on two ends of the right side, and the flat plane guide 75 is in the middle of the left side. The bottom structure of the slot guide 73 is upside down U ( [symbol] ) shape groove 731, also the bottom structure of the slot guide 74 is upside down U ( [symbol] ) shape groove 741, and the bottom of the flat plane guide 75 is a plane structure. At the front and rear ends of the bottom bracket 7 there are two positioning pins 71, and a rotation pivot pin 72 is formed at the rear end of the bottom bracket 7.

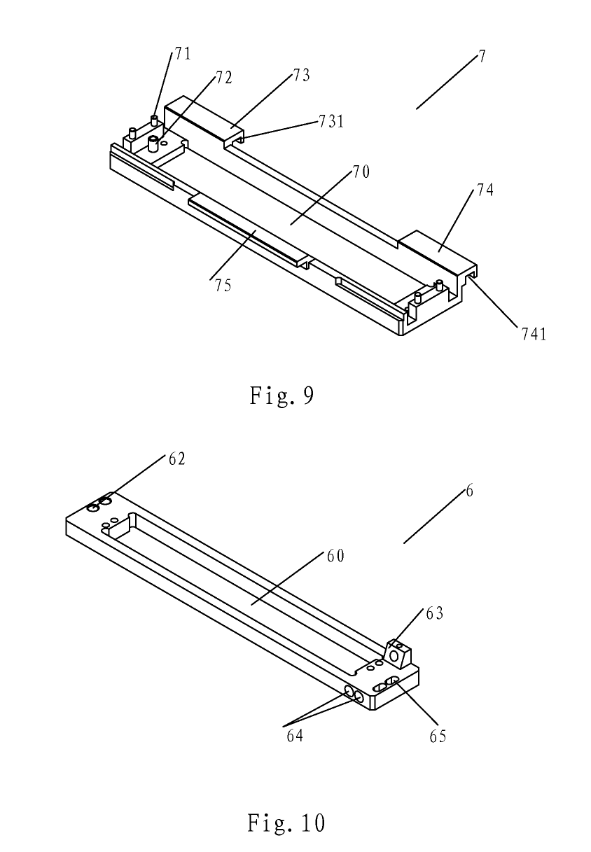

As shown in FIG. 10, top bracket 6 has a mounting hole 66 and a through hole 62 at the rear end of the top bracket 6. At the front end of the top bracket 6 set a mounting block 63 which is used to mounting the angle adjustment mechanism 61.

Two top bracket blind holes 64 are on the front left side at the front end of top bracket 6. A angle restoring spring (in an xyz Cartesian coordinate system) is placed in the top bracket blind hole 64. The top bracket 6 is mounted on the bottom bracket 7 by bracket fixing block 5 and the spring loaded screw 51 and locking screw 52 on it. The spring loaded screw 51 and locking screw 52 go through the slotted hole 65, which is at the front end of the top bracket 6, to reach the bottom bracket 7. Each spring loaded screw 51 is equipped with a compressed spring 53.

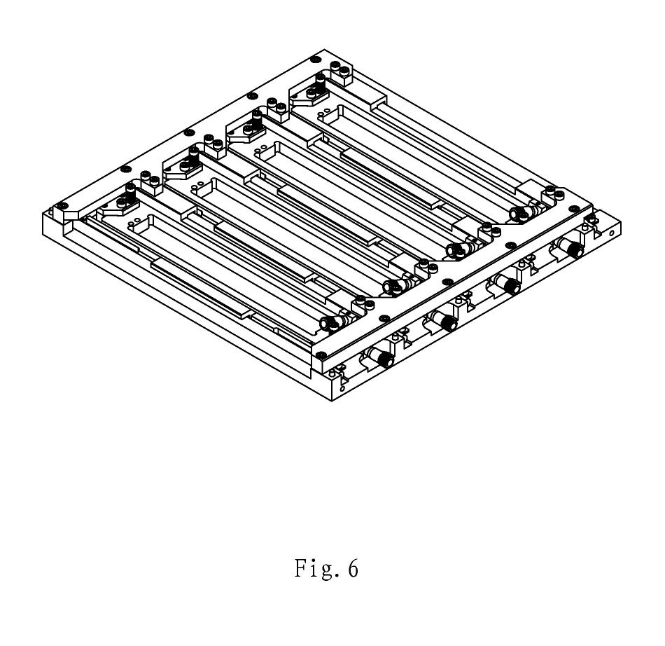

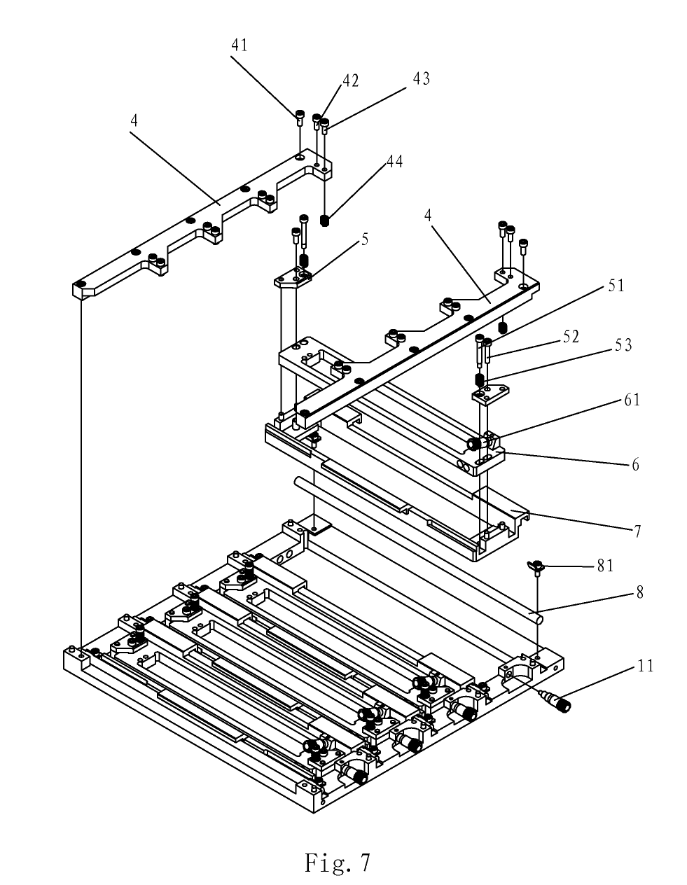

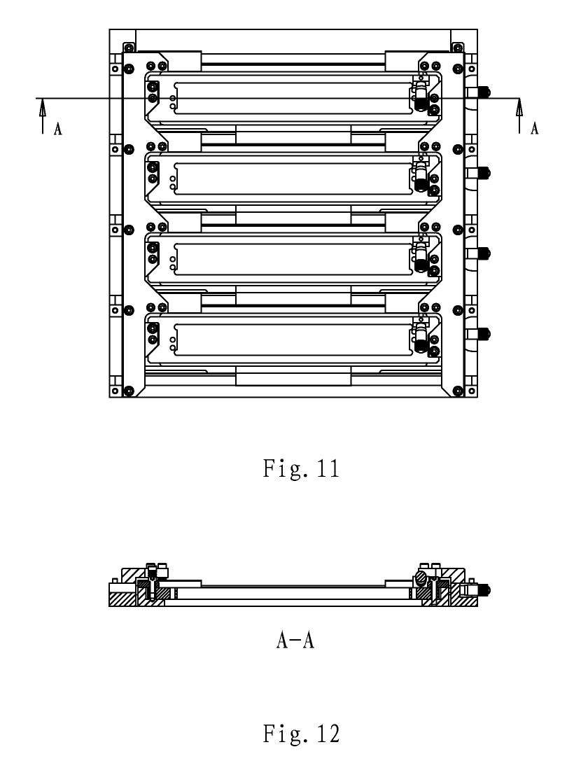

As shown in FIGS. 6, 7, 11 and 12, During assembly, put the stainless steel round shaft 8 into the L-shaped corner slots 14, and fix the stainless steel round shaft 8 on the base plate 1 with fixing plate 81 and screws. Then put the Y-axis restoring spring into the base plate blind hole 13 and install the Y-axis adjustment mechanism 11 on the base plate 1. Then put the bottom bracket 7 on the stainless steel round shaft 8. The upside down U ( [symbol] ) shape groove 741 of slot guides 73 and 74 on the bottom bracket 7 are contact with one stainless steel round shaft 8, and the bottom of the flat plane guide 75 is contact with another stainless steel round shaft 8. Let the bottom bracket 7 move along the stainless steel round shaft 8 back and forth. There are two ends of the Y-axis restoring spring, one in contact with the bottom of the base plate blind hole 13, the other in contact with the side wall of the bottom bracket 7.

Next, put the angle restoring spring into the top bracket blind hole 64 which is formed on the top bracket 6. Then put the top bracket 6 inside the bottom bracket 7. The through hole 62, which is formed on the top bracket 6, is fitted with the rotation pivot pin 72 on the bottom bracket 7. There are two ends of the angle restoring spring, one in contact with the bottom of the top bracket blind hole 64, the other in contact with the side wall of the bottom bracket 7. And then install the angle adjustment mechanism 61 on the mounting block 63 of the top bracket 6. The top bracket 6 can rotate around the rotation pivot pin 72 by adjusting the angle adjustment mechanism 61.

Next, put the bottom bracket 7 fixed on the top bracket 6 by the bracket fixing block 5 and the spring loaded screw 51 on it. Two positioning pins 71 on two ends of the bottom bracket 7 which are used to position the bracket fixing block 5. When locking the locking screw 52, the top bracket 6 will not move to another position. Then mounting the other three bottom bracket 7 and top bracket 6 follow the above steps.

Finally, install both front and rear fixing bar 4 on the base plate 1 by the screw 41, and locking the four bottom bracket 7 with the spring loaded screw 43, Obtain the adjusting parts in embodiment of the present invention as shown in the FIG. 6.

After assembly, the bottom bracket 7 can move along the stainless steel round shaft 8 back and forth by adjusting the Y-axis adjustment mechanism 11, and the top bracket 6 can rotate around the rotation pivot pin 72 by adjusting the angle adjustment mechanism 61.

In the embodiment of the present invention, the number of the Y-axis adjustment mechanisms 11 and the number of the angle adjustment mechanisms 61 are equal with the number of the print heads mounted on the base plate 1.

In the embodiment of the present invention, the Y-axis adjustment mechanism 11 and the angle adjustment mechanism 61 are micrometer screw heads for fine precision adjustments. In practice, finish screws, adjusting screws and eccentric screws can also be used as the adjustment mechanism.

After completing the adjusting parts assembly, install print head 2 on head mounting bracket 3, and then install the head mounting bracket 3 with print head 2 on the adjusting parts from the bottom up, and lock them with the positioning pin 32 and locking screw 33 on the head mounting bracket 3.

In the embodiment of the present invention, the print head can move along the Y-axis direction and can rotate around rotation pivot pin 72; that is to say, the present mechanism can adjust the distance in Y-axis direction of the four print heads and the angular position of the four print heads. First adjust the angular position of the print heads.

Before adjusting, loosen the locking screw 52, then adjust the angle adjustment mechanism 61, which pushes the bottom bracket 7 to make the top bracket 6 rotated around the rotation pivot pin 72. As the print head 2 is mounted on the top bracket 6, the print head 2 also rotates around the rotation pivot pin 72 to reach the desired position.

A condition of the vertical arrangement of the print head base plate requires the angle between every print head and the vertical line to be 0; that is to say, all the print heads must be completely parallel with the reference head's Y axis. The present mechanism can also be used in for a slant arrangement on the print head base plate by adjusting the angle between every print head and the vertical line to a fixed value more than 0.

In the embodiment of the present invention, when making adjustments, the adjusted parts never come in contact with the print heads. It can prevent the print heads from damage when multiple adjustments are required.

As angle adjustment mechanism 61 pushes the top bracket 6, the angle restoring spring in the top bracket blind hole 64 provides a continuous reverse rotating force to the top bracket 6. If the angular position of the print head 2 is over adjusted, the reverse rotation of the angle adjustment mechanism 61 automatically moves the print head 2 back. After adjusting the angular position of the print head, lock the top bracket 6 on the bottom bracket with the locking screw 52.

Then adjust the Y-axis position of the print heads after adjusted the angular position of the print heads. When adjusting, first loosen the locking screw 42. Adjust the Y-axis adjustment mechanism 11 to push the bottom bracket 7 along the stainless steel round shaft 8. The top bracket 6 will take the print head 2 move along the Y-axis to the required position. The Y-axis restoring spring in the base plate blind hole 13 provides a continuous reverse moving force to the top bracket 6. If the print head is adjusted beyond the desired Y-axis position, the reverse rotation of the first adjustment mechanism 11 automatically moves the print head 2 back.

In the embodiment of the present invention, it requires the first nozzle of all the print heads to be in a horizontal line to printing color images or text, or to improve printing speed.

In the embodiment of the present invention, the print heads can also be staggered to improve the printing resolution.

In the embodiment of the present invention, the adjusting process allows the adjusting parts to never contact the print heads. It can prevent damage to the print heads after many adjustments. After the print head 2 is adjusted to the required position in the Y-axis direction, lock the bottom bracket 7 with the locking screw 42.

Additionally, there are spring loaded screws 43 and 51 beside each of the locking screws 42 and 52. After the print head reaches the requirement position by adjusting the Y-axis adjustment mechanism 11 and/or the angle adjustment mechanism 61, even without locking the locking screws 42 and 52, the print heads will not move to another position in the condition that there is no external force. The restoring spring will not change the position of the print head.

When one print head breaks down, loosen the screw 33 and put a screw into the thread hole 35 on the head mounting bracket 3. The print head assembly will separate from the adjusting parts. Then the print head can be easily removed. The adjusting parts are kept immobile when remounting the print head, so it needs no or just a little adjustment to reach the requirement position.

### Second Embodiment

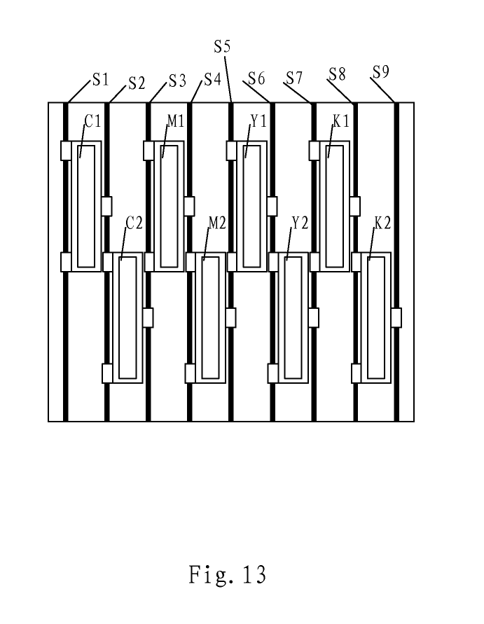

In another embodiment of the present invention, As shown in FIG. 13. The present print head mounting and adjusting mechanism can be used in page width printing. For example, in order to get two print head width printing, in four colors (C,M,Y,K) printing, use eight print heads C1-C2, M1-M2, Y1-Y2, K1-K2 arranged in two rows, nine stainless steel round shaft S1-S9 support the eight print heads. The embodiment use two print heads to printing one color ink, the print head C1 and C2 are used to printing cyan ink, the print head M1 and M2 are used to printing magenta ink, the print head Y1 and Y2 are used to printing yellow ink, the print head K1 and K2 are used to printing black ink. By adjusting the angle adjustment mechanism all the print heads are parallel to each other, and by adjusting the Y-axis adjustment mechanism the distance between the first nozzle of print head C2 and the last nozzle of print head C1 is d, d is the distance between two adjacent nozzles in one print head.

As the present invention may be embodied in several forms without departing from the spirit or essential characteristics thereof, it should also be understood that the above described embodiments are not limited by any of the details of the foregoing description unless otherwise specified, but rather should be construed broadly within its spirit and scope as defined in the appended claims, and therefore all changes and modifications that fall within the metes and bounds of the claims, or equivalence of such metes and bounds, are therefore intended to be embraced by the appended claims.

What is claimed is:

1. A print head mounting and adjusting mechanism include a bottom bracket and a base plate, the bottom bracket is installed on the base plate, the bottom bracket can be used for mounting print head, the bottom bracket is mounted on the base plate to provide accurate Y-axis movement and adjustment, wherein also include a top bracket which is mounted on the bottom bracket for providing angle adjustment of the print head.

2. A print head mounting and adjusting mechanism according to claim 1, wherein the front end of the top bracket is provided with a mounting block for mounting the angle adjustment mechanism.

3. A print head mounting and adjusting mechanism according to claim 1, wherein one end of the top bracket is provided with a through hole which mate with the rotation pivot pin which is formed on the bottom bracket.

4. A print head mounting and adjusting mechanism according to claim 2, wherein the number of angle adjustment mechanisms is equal with the number of the print heads designed on the base plate.
